(19) United States
(12) Patent Application Publication
(10) Pub. No.: US 2014/0069920 A1
(43) Pub. Date: Mar. 13, 2014

(54) CLOSURE SYSTEM

(71) Applicant: Impress Australia Pty Ltd., (US)

(72) Inventors: Andrew Tuan Tang, Abbotsford(Victoria) (AU); William Howard Barling, Hawthorn(Victoria) (AU); Donn Bede Hawthorne, Hawthron(Victoria) (AU); Andrew Owens, Broadmeadows(Victoria) (AU)

(73) Assignee: Impress Australia Pty Ltd., Abbotsford (AU)

(21) Appl. No.: 13/829,120

(22) Filed: Mar. 14, 2013

Related U.S. Application Data
(63) Continuation of application No. 13/561,585, filed on Jul. 30, 2012, now abandoned.
Application No. 13/561,585 is a continuation of application No. 13/316,955, filed on Dec. 12, 2011, now abandoned.
Application No. 13/316,955 is a continuation of application No. 13/092,257, filed on Apr. 22, 2011, now abandoned.
Application No. 13/092,257 is a continuation of application No. 12/806,782, filed on Aug. 19, 2010, now abandoned.
Application No. 12/806,782 is a continuation of application No. 12/593,737, now abandoned.

(30) Foreign Application Priority Data
Mar. 30, 2007 (AU) 2007901666

(51) Int. Cl. B65D 51/18; B32B 15/082

(52) U.S. Cl. CPC B65D 51/185; B32B 15/082
USPC 220/265; 428/457; 428/340; 428/335; 428/463

(57) ABSTRACT

A foil of a tagger ring foil (TRF) closure system for a container, such as a can, is provided. The foil comprises a composite of two or more layers made from different materials instead of aluminum only.

### CROSS-REFERENCE TO RELATED APPLICATIONS

This application is a continuation of U.S. application Ser. No. 13/561,585 filed Jul. 30, 2012, which is a continuation of U.S. application Ser. No. 13/316,955 filed Dec. 12, 2011, which is a continuation of U.S. application Ser. No. 13/092,257 filed Apr. 22, 2011, which was a continuation of U.S. application Ser. No. 12/806,782 filed Aug. 19, 2010, which was a continuation of U.S. application Ser. No. 12/593,737 filed Sep. 29, 2009, which was a national stage filing under 35 U.S.C. 371 of PCT/AU2008/000441 filed Mar. 28, 2008, which International Application was published by the International Bureau in English on Oct. 9, 2008, and which International Application claims priority to Australian Application No. 2007901666, filed Mar. 30, 2007, each of which are hereby incorporated herein in their entirety by reference.

### FIELD OF THE INVENTION

The present invention relates to containers having a closure system that provides a high barrier to moisture or oxygen.

The present invention relates particularly, although by no means exclusively, to containers made from metal.

### DESCRIPTION OF RELATED ART

Certain dry products are highly sensitive to moisture in that the products degrade due to absorption of moisture. For example, milk powders and infant formulations contain labile vitamins which may degrade rapidly if excessive moisture levels are reached. As a further and more extreme example, certain types of nutritional/flavoured milk additives have been found by the applicant to be extremely moisture sensitive, requiring less than a 2% increase in weight due to moisture pickup to become unusable.

Other products are very sensitive to oxygen in that the products degrade due on exposure to oxygen. Products in this category include, for example, instant coffee, infant formula, milk powder, drink concentrates. Many of these products are also sensitive to moisture.

In order to avoid moisture and/or oxygen contact, products of the types described above have traditionally been and are still packed in hermetically sealed metal cans. For ease of access, high performance re-sealing, and tamper evidence, the metal cans typically comprise a closure system referred to in the art as a “tagger ring and foil” (TRF) closure system.

A traditional TRF system comprises a first component in the form of a “ring”, a second component in the form of a “lever plug”, and a third component in the form of a foil sheet.

The ring of the traditional TRF system is adapted to be sealed to a can body by a process of double seaming as understood in the art of can manufacture and comprises a flowed-in sealant also according to the known art. The sealant is typically a rubber composition that provides desirable sealing properties under compression. The ring further comprises a central orifice. The orifice is defined by an annular wall having an edge that extends into the container.

The lever plug of the traditional TRF system comprises a flat panel that is formed to dose the orifice with an interference fit. The lever plug further comprises a flange that extends outwardly from the panel above the vertical wall of the orifice when the plug is positioned in the orifice. The flange prevents the plug being pushed inside the can and makes it possible to lever the plug out of the can with an appropriate implement such as a spoon to thereby gain access to the contents of the can.

For the purposes of this specification a seal resulting from an interference fit is understood to be a seal provided by forcing one component of controlled diameter, in this case a lever plug, into an orifice of controlled diameter in another component, in this case a ring, where the diameter of the one component, i.e. the lever plug, is greater than or equal to the diameter of the other component, i.e. the orifice in the ring.

The foil of the traditional TRF system is located inside the can and extends from a seaming flange on the ring across the entire end of the can. The foil is restrained in the seaming flange and is encapsulated in the double seam at sealing. The foil may be restrained by applying sealing material over an edge of the foil.

In use, the foil provides an hermetic seal for the contents of a can up to the time that a consumer opens the can and ruptures the foil. Thereafter, the interference fit between the ring and the lever plug makes it possible to re-seal the can with sufficient moisture barrier to maintain product quality during successive cycles of removing the lever plug and removing contents from the can and then inserting the lever plug back into the can and re-sealing the can.

For reasons of strength, aluminium foil has traditionally been used as the foil in traditional TRP closure systems. However, aluminium foil is expensive. In addition, aluminium foil can form sharp edges when the foil is ruptured to enable access to a can and the sharp edges can cut consumers as the consumers remove the contents of the can from the can. The applicant has found that this is a particularly serious issue from the viewpoint of marketability of the cans. Further, in times of increasing environmental consciousness, the use of aluminium foil as a seal in a metal can, such as a steel can, is undesirable as the aluminium is a contaminant when re-cycling the metal can.

For the above reasons, there is a need for an alternative to the traditional TRF closure system that does not include the use of an aluminium foil at all or at least reduces the amount of aluminium in the TRF system compared to the amount of aluminium the traditional TRF closure system and that can be used in a conventional manufacturing process for cans or other containers.

In particular, there is a need for an alternative to the traditional TRF closure system that addresses the issue of sharp edges that form when the aluminium foil of the traditional TRF closure system is ruptured.

The above description is not to be taken to be an indication of the common general knowledge in Australia or elsewhere.

### SUMMARY OF THE INVENTION

According to the present invention there is provided a foil of a tagger ring foil (TRF) closure system for a container, such as a can, that comprises a composite of two or more layers made from different materials instead of aluminium only.

Preferably the materials that form the layers of the composite foil and the combination of the layers are selected so that, in use, when the foil is part of a TRF closure system on a container and the foil is ruptured to gain access to the contents of the container, the ruptured foil does not form with a sharp edge that can cut consumers.

Preferably the materials that form the layers of the composite foil and the combination of the layers are selected so that the foil can be processed in a conventional container manufacturing process that includes forming the container with a TRE closure system.

Preferably the composite foil has a board burst strength, when measured with Australian Standard (AS) 1301.438s, of less than 400 KPa.

Preferably the composite foil has a cross direction ring crush resistance pressure, defined as the ring crush measured using AS 1301,407s, divided by 0.152 and multiplied by the foil thickness measured using AS 1301.426s, of less than 10 MPa.

The applicant has found that the parameters of the board burst strength and the ring crush resistance pressure of a foil provides an indication of the “hardness” of the foil and hence the likelihood of a ruptured foil presenting a sharp edge that could cut a consumer.

In addition, the applicant has found that the composite foil makes it possible to reduce if not replace altogether the aluminium of the aluminium foil of the traditional TRF closure system while retaining moisture and oxygen performance and being able to process the foil in a conventional container manufacturing process that includes forming the container with a TRF closure system

Preferably the composite foil comprises a composite of the following layers: paper layer, a first polymer layer, a metal (including a metal alloy) layer, and a second polymer layer. With this arrangement, the main functions of the paper layer are: (a) bulk at low cost, (b) high tensile strength to permit seaming without fracture, (c) easy tearing for consumer access to the contents of a container, and (d) minimise risk of a consumer being cut by exposed edges of a ruptured composite foil. The main function of the first polymer is to adhere together the paper layer and the metal foil layer. The main function of each of the metal layer and the second polymer layer is to provide moisture and oxygen barrier properties

Preferably the paper ranges in thickness between 25 and 100 gsm.

Preferably the first polymer layer ranges in thickness of between 10 and 30 um.

Preferably the polymer of the first polymer layer comprises a co-extrusion of a low density polyethylene co-extruded and an acrylic acid resin such as ethylene acrylic acid resin.

Preferably the metal of the metal layer of the composite foil comprises aluminium.

Preferably the metal layer has a thickness of between 7 and 60 um.

More preferably the metal layer has a thickness of less than 40 um.

More preferably the metal layer has a thickness of between 20 um and 40 um.

Preferably one of the layers comprises a filler added for the purpose of reducing the board burst or ring crush resistance pressure to a required level.

The composite foil may comprise any combination of materials needed to achieve a required moisture and oxygen barrier, board burst strength and ring crush resistance pressure.

Preferably the composite foil is applied to a can so the paper side of the foil is an outward facing side of the foil.

According to the present invention there is also provided a tagger ring foil (TRF) closure system for a container, such as a can, that comprises the above-described composite foil.

According to the present invention there is also provided a container, such as a can, that comprises the above tagger ring foil (TRF) closure system.

Preferably the composite foil of the closure system is applied to the container so that the paper side of the foil is an outward facing side of the foil.

Preferably the container is a metal container.

### Results of Foil Testing

The importance of an appropriate board burst strength and ring crush resistance pressure is illustrated in the following examples that relate to test work on a group of samples.

In the examples:
The thickness of samples was measured using AS 1301.426s.
The board burst strength of samples was measured using the board burst test according to AS 1301.438s.
The ring crush resistance pressure of samples was measured using AS 1301.407s.
The ring crush resistance pressure of a composite foil sample in accordance with the present invention was measured in a cross direction of the paper layer of the foil sample. The foil sample comprised the following layers: paper, a first polymer, aluminium foil, and a second polymer.
The cutting ability of the samples was assessed on the basis of an assumption that this is related to the ring crush resistance pressure divided by the cross sectional area of a sample being crushed. The length of a ring crush sample was 152 mm. Prom the measured ring crush resistance, pressure and the thickness of the sample a parameter, hereafter referred to as ‘ring crush resistance pressure’, was determined by dividing the measured ring crush resistance pressure value by 152 mm and the measured thickness.
The ability of the samples to cut fingers was determined subjectively using a fingertip hardness' test by a laboratory technician determining how hard a sample feels against his/her fingertips.

The applicant tested the board burst strength and ring crush resistance pressure of the samples on the basis that these parameters are good indicators of fingertip hardness of the samples, with harder samples being more likely to cut consumers.

Burst was chosen as a test as the board burst test, which involves a hydraulic piston driving a rubber diaphragm about 25 mm in diameter through a sheet of material, is thought to replicate a consumer seeking to burst through a sheet of unbroken foil of a TRF closure system on a can to gain access to the contents of the can.

A series of aluminium and composite foil samples were measured and tested as described above. The cutting ability of the different samples was subjectively assessed.

The samples received were aluminium foil samples of nominal thicknesses of 100 um, 90 um, 60 um, 30 um and 15 um. The performance of this traditional foil material was compared to that of one embodiment of a composite foil in accordance with the present invention, as described above. The composite foil had a nominal thickness of 120 um.

The results of the tests are shown in Table 1 below.

TABLE 1
Results of testing aluminium and composite foil samples.

| | | | | Ring crush | |
|---|---|---|---|---|---|
| | Measured | Board | Ring | resistance | |
| | thickness, | burst, | crush, | pressure, | Fingertip |
| Sample | um | KPa | N | MPa | hardness |
| ‘100 um’ | 106 | 1087 | 388 | 24.1 | High |
| aluminium foil | | | | | |
| ‘90 um’ | 101 | 929 | 308 | 20.0 | High |
| aluminium foil | | | | | |
| ‘60 um’ | 67 | 735 | 158 | 15.5 | Medium |
| aluminium foil | | | | | |
| ‘45 um’ | 50 | 470 | 87 | 11.5 | Medium |
| aluminium foil | | | | | |
| ‘30 um’ | 31 | — | 39 | 8.3 | Soft |
| aluminium foil | | | | | |
| ‘15 um’ | 16 | — (*) | 6 | 2.6 | Soft |
| aluminium foil | | | | | |
| Composite foil | 122 | 343 | 115 | 6.2 | Soft |

Although the board burst strength for the 15 um sample was not measured, the sample was measured with the similar paper burst test, AS 1301.403s. A value of 77 kPa was measured. Overall, the board burst and paper burst strengths were broadly' comparable, for example the composite foil sample had a paper burst strength of 312 kPa and a board burst strength of 343 kPa.

Table 1 shows that:
The board burst strength and the ring crush resistance pressure of the traditional aluminium foil samples reduced significantly with a reduction in thickness. However, whilst these results suggests that reducing the thickness of aluminium foil used in traditional TRF closure systems is one option for minimising the current cutting problem, this is not an option form the viewpoint of manufacturing on current can manufacturing lines.
The fingertip hardness of the traditional aluminium foil also changes as the thickness of the aluminium changes, moving from hard to soft.
As indicated above, the properties of board burst strength and ring crush resistance pressure are good indicators of fingertip hardness. The results indicate that values of 400 kPa and 10 MPa, respectively, for board burst strength and ring crush resistance pressure are approximate dividing lines between soft and hard samples.

### DESCRIPTION OF THE DRAWINGS

The present invention is described further by way of example with reference to the accompanying drawings, of which:

FIG. 1 is a transverse section of a traditional TRF closure system;

FIG. 2 is a detailed section of the area circled as “A” in FIG. 1; and

FIG. 3 is a section of one embodiment of a TRF closure system in accordance with the present invention which shows the multiple layers of material that make up the system.

### DETAILED DESCRIPTION OF THE INVENTION

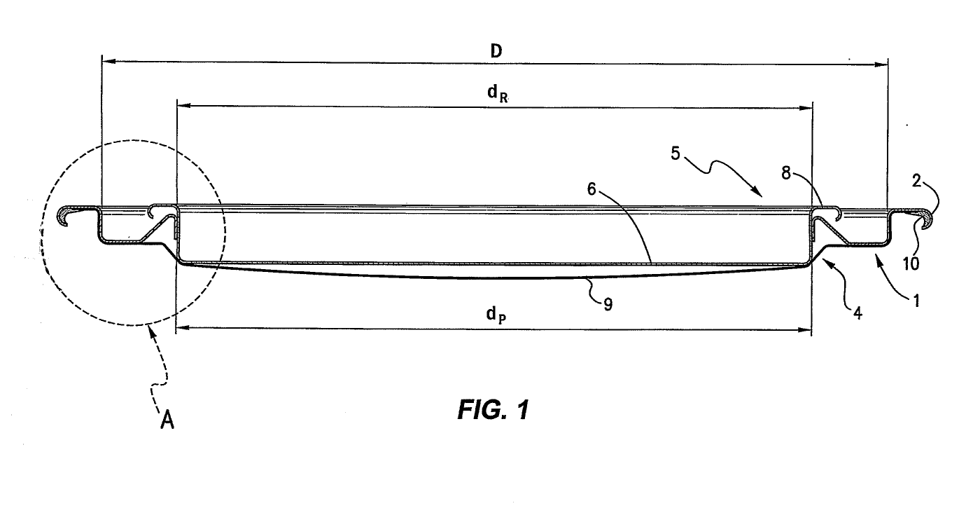

FIG. 1 shows a traditional TRF closure system of the known art.

The traditional TRF system comprises a ring 1, a plug 5, and a foil 9.

The ring 1 of the traditional TRF system comprises a seaming curl 2, a vertical sealing surface 3 that defines an orifice to allow access to a container, and an inwardly facing cut edge 4 of a foil.

The plug 5 of the traditional TRF system comprises a panel 6, a substantially vertical sealing surface 7, and an outwardly extending flange 8 allowing the plug to he levered from the orifice in the ring.

The foil 9 of the traditional TRF system extends across the inside of the TRF system to the sealing material 10 around the periphery in the seaming curl 2. Alternately, the foil 9 can be heat sealed to a flat section of the ring, not shown. The foil 9 provides the primary seal for extended shelf life prior to opening.

The traditional TRF closure system has 3 critical dimensions, namely a nominal diameter D measured as shown, a ring diameter d_{R}, and a plug diameter dₚ. The interference seal between the ring 1 and the plug 5 is provided by selecting dₚ to be sufficiently larger than d_{R} so that a seal and grip is achieved, but not so large that insertion of the plug is excessively difficult. The range of acceptable interference is known to those skilled in the art and is embodied in manufacturing specifications for such parts.

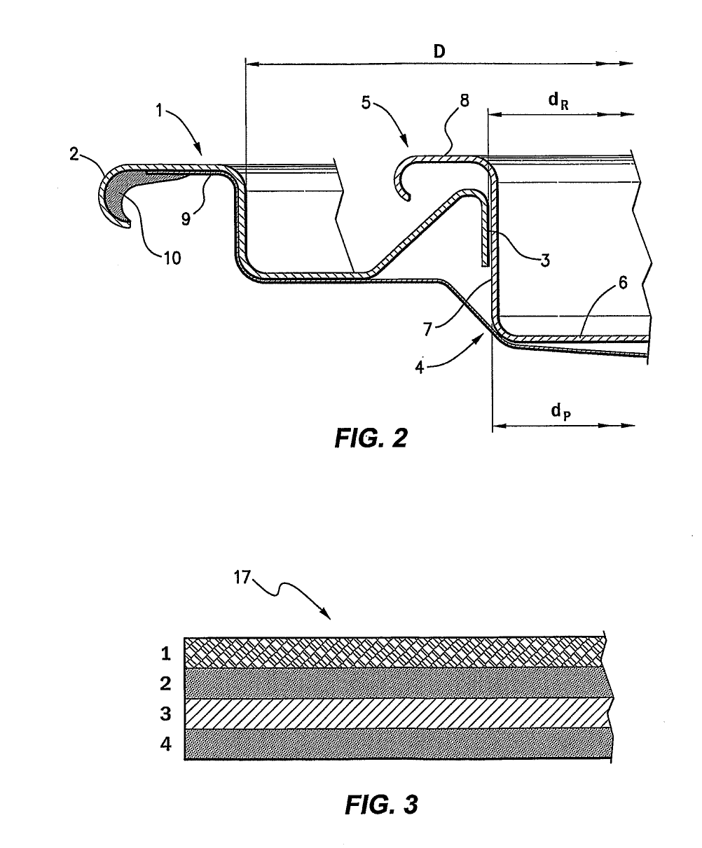

FIG. 2 shows in greater detail the critical seal areas of the traditional TRF System.

FIG. 3 shows one embodiment of the composite foil 17 of the present invention. The composite foil comprises successive layers of paper layer 1, a polymer layer 2, an aluminium foil layer 3, and another polymer layer 4.

The paper may be any suitable paper. Suitable paper includes a 35 gsm or 50 grams per square metre (gsm) bleached kraft sheet made by Australia Paper. Alternative options include grammages ranging from 25 to 100 gsm. The functions of the paper layer 1 are: (a) bulk at low cost, (b) high tensile strength to permit seaming without fracture, (c) easy tearing for consumer access, and (d) minimise risk of a consumer being cut by exposed edges of a ruptured composite foil.

The polymer layer 2 comprises a co-extruded copolymer of (a) a low density polyethylene (LDPE) in the section of the layer 2 that joins the paper layer 1 and (b) an ethylene acrylate acid resin adjacent the aluminium foil. The LDPE layer is about 2/3 of the total of thickness of the layer 2. The thickness of the layer 2 ranges from 8 to 30 um, and is preferably 12 um. The polymer layer 2 is provided to adhere together the paper layer 1 and the aluminium foil layer 3. The LDPE is selected on the basis of its capacity to adhere to paper and the ethylene acrylate acid resin is selected on the basis of its capacity to adhere to aluminium.

The aluminium foil layer 3 in the composite foil is 30 um in thickness, but could conceivably range from 15 to 60 um in thickness. The function of the aluminium foil is to provide high oxygen and moisture barrier properties, both of which are important for long term shelf stability of an unopened container. The aluminium foil layer 3 also contributes to the mechanical properties of the composite foil.

The bottom layer 4 is a co-extruded co-polymer. The bottom layer comprises (a) a LDPE filled with 30% talc to weaken the overall structure, with this material forming an exposed surface of the composite foil and (b) a terpolymer of ethylene methyl or butyl acrylate grafted with a maleic anhydride to adhere the layer 4 to the aluminium foil layer 3. Preferably the thickness of this layer is 20 um, but can conceivably range from 15 to 50 um. An important function of the bottom layer 4 is to protect the aluminium of the foil layer 3 from oxidation and other undesirable chemical reactions and to provide a layer of a material that is approved for direct food contact.

Many modifications may be made to this invention shown without departing from the spirit and scope of the invention.

That which is claimed:

1. A foil of a tagger ring foil (TRF) closure system for a container, such as a can, comprising a composite of two or more layers made from different materials instead of aluminum only and having a board burst strength, when measured with Australian Standard (AS) 1301.438s, of less than 400 KPa and/or a cross direction ring crush resistance pressure, defined as the ring crush measured using AS 1301.407s, divided by 0.152 and multiplied by the foil thickness measured using AS 1301.426s, of less than 10 MPa.

2. The foil defined in claim 1 wherein the materials that form the layers of the composite foil and the combination of the layers are selected so that, in use, when the foil is part of a TRF closure system on a container and the foil is ruptured to gain access to the contents of the container, the ruptured foil does not form a sharp edge.

3. The foil defined in claim 1 wherein the materials that form the layers of the composite foil and the combination of the layers are selected so that the foil can be processed in a conventional container manufacturing process that includes forming the container with a TRF closure system.

4. The foil defined in claim 1 comprising a composite of the following layers: paper, a first polymer, a metal and a metal alloy, and a second polymer.

5. The foil defined in claim 4 wherein the paper ranges in thickness between 25 and 100 gsm.

6. The foil defined in claim 4 wherein the first polymer layer ranges in thickness of between 10 and 30 μm.

7. The foil defined in claim 4 wherein the polymer of the first polymer layer comprises a low density polyethylene co-extruded with an acrylic acid such as ethylene acrylic acid.

8. The foil defined in claim 4 wherein the metal of the metal layer comprises aluminum.

9. The foil defined in claim 4 wherein the metal layer has a thickness of between 7 and 60 μm.

10. The foil defined in claim 1 further comprising a filler for reducing the board burst or ring crush resistance pressure to a required level.

11. A tagger ring foil (TRF) closure system for a container, such as a can, that comprises the composite foil defined in claim 1.

12. A container, such as a can, that comprises the tagger ring foil (TRF) closure system defined in claim 11.

13. The container defined in claim 10 wherein the composite foil of the closure system is applied to the container so that a paper side of the foil is an outward facing side of the foil.

14. The container defined in claim 12 wherein the container is a metal container.
